(19) United States
(12) Patent Application Publication
(10) Pub. No.: US 2008/0023079 A1
(43) Pub. Date: Jan. 31, 2008

(54) Valve for Use in a Fuel Line of a Motor Vehicle

(75) Inventors: Lothar Dickenscheid, Ockenheim (DE); Dirk Mohring, San Jose, CA (US)

Correspondence Address: HANLEY, FLIGHT & ZIMMERMAN, LLC, 150 S. WACKER DRIVE, SUITE 2100, CHICAGO, IL, 60606, US

(73) Assignee: Siemens Aktiengesellschaft, Munchen (DE)

(21) Appl. No.: 11/658,238

(22) PCT Filed: Jul. 26, 2005
(86) PCT No.: PCT/EP05/53640

§ 371 Date: Aug. 9, 2007

(30) Foreign Application Priority Data
Jul. 30, 2004 (DE) 10 2004 037 419.8

(51) Int. Cl. F16K 15/00

(52) U.S. Cl. 137/511

(57) ABSTRACT

The invention concerns a valve (1) for use in a fuel line of a motor vehicle, comprising a sealing seat (7), a valve body (5) which closes the sealing seat (7) and a spring device (6, 16, 17), which pre-tensions the valve body (5) against the sealing seat (7). The side of the valve body (5) facing the sealing seat (7) has a contour (11) for deflecting the volume flow over an angle of greater than 90° and the outer diameter of the contour (11) is greater than the diameter of the sealing seat (7).

The subject of the invention is a valve for use in a fuel line of a motor vehicle, comprising a sealing seat, a valve body which closes the sealing seat, and a spring device, which pretensions the valve body against the sealing seat. Such valves are used in fuel lines as a non-return valve or pressure-limiting valve.

Such valves have long been known in the state of the art. The valve is often arranged in a housing, which has an inlet and an outlet. The inlet has a sealing seat, on which the valve body sits, pretensioned by the spring device, thereby sealing the inlet. The fuel flowing through the inlet is therefore prevented from flowing further. Only when the pressure in the inlet exceeds the force generated by the spring device is the valve body moved away from the sealing seat. Fuel can flow through the now opened inlet around the valve body to the outlet.

Various disk-shaped components are used as valve body. In order to improve the flow around the valve body, the use of balls or hemispherical components as valve body is also known. Whereas in disk-shaped valve bodies the fuel flow is deflected by 90° in order to flow around the valve body, spherical valve bodies require a deflection of the fuel flow by an angle of less than 90°. Pressure losses occurring due to the deflection mean that these valves have a rising characteristic curve. This means that the pressure rises as the volume flow increases. This is often a considerable disadvantage, particularly in the case of a valve used as pressure-limiting valve in a feed line leading to an internal combustion engine of a motor vehicle since the pressure in the feed line should be constant irrespective of the volume flow. The known valves can therefore be used only for a limited volume flow, dependent upon the rise in the characteristic curve.

The object of the invention therefore is to create a valve which ensures a virtually constant pressure in the feed line at different volume flows. The valve should furthermore be of simple construction and easy to assemble.

According to the invention the object is achieved in that the valve body, on its side facing the sealing seat, has a contour for deflecting the volume flow by an angle of more than 90°, and that the outside diameter of the contour is greater than the diameter of the sealing seat.

With this contour the valve body directs the volume flow counter to the pressure forces acting on the valve body. This deflection of the flow causes additional pulsation forces to act on the valve body. As a result of this flow deflection, valves with an especially shallow characteristic curve can be achieved. This means that the pressure remains constant virtually irrespective of the volume flow. A further substantial advantage of the valve is that the valve is of simple construction and requires no more parts than conventional valves.

The contour of the valve body is advantageously designed in such a way that the volume flow is deflected within an angular range of 100° to 170°, the angle being the angle in relation to the axis of the valve body in the direction of flow.

For achieving an especially shallow valve characteristic curve, a contour of the valve body which deflects the volume flow within an angular range of 120° to 150° has proved effective.

The contour for the deflection of the volume flow is particularly easy to produce in that on its side facing the sealing seat the valve body has a radially outer peripheral elevation for deflecting the flow.

A simple valve construction is also achieved in that the radially inner flank of the radially peripheral elevation takes the form of a sealing face and interacts with the sealing seat. Additional sealing means are therefore not necessary.

It is also feasible, however, for improved sealing, to provide an area on the radially inner flank, which by means of specially shaped elements is made to conform to the sealing seat situated on the inlet. Such shaped elements may be a step or a sealing lip, for example. Because of their relatively small dimensions, such shaped elements have virtually no perturbing influence on the deflected volume flow.

The deflection of the volume flow is facilitated if the face of the valve body enclosed by the peripheral elevation is of concave design.

An improved deflection of the volume flow is achieved, on the other hand, by a valve body contour which has a centrally arranged elevation in the face enclosed by the peripheral elevation. The centrally arranged elevation means that the volume flow incident upon the valve body is deflected radially outwards and counter to the direction of flow.

In a further advantageous embodiment the contour of the valve body between the centrally arranged elevation and the peripheral elevation has a continuous profile, with the result that a deflection of the volume flow is achieved which is especially free of turbulence and hence loss-free.

The simple construction allows the valve to be readily incorporated into lines. The design of the valve with a housing moreover allows the valve to be arranged at any point.

In an especially simple embodiment the spring device is a helical coil spring. The relatively small diameter of helical coil springs means that the valve can likewise be designed with a small diameter.

A further advantage is that the helical coil spring can be arranged both upstream and downstream of the valve body in the direction of flow. The arrangement of the helical coil spring upstream of the valve body in the direction of flow has the advantage that this arrangement exhibits a smaller oscillatory response of the valve body.

In a further development the spring device takes the form of a disk spring. Lateral recesses in the disk spring ensure passage of the medium. A valve designed in this way takes up an especially small amount of overall space in its axial extent.

In another development a valve with a small axial extent is achieved in that the spring device is a leaf spring. The leaf spring is advantageously fixed to the housing.

The invention will be explained with reference to a number of exemplary embodiments. In the drawings

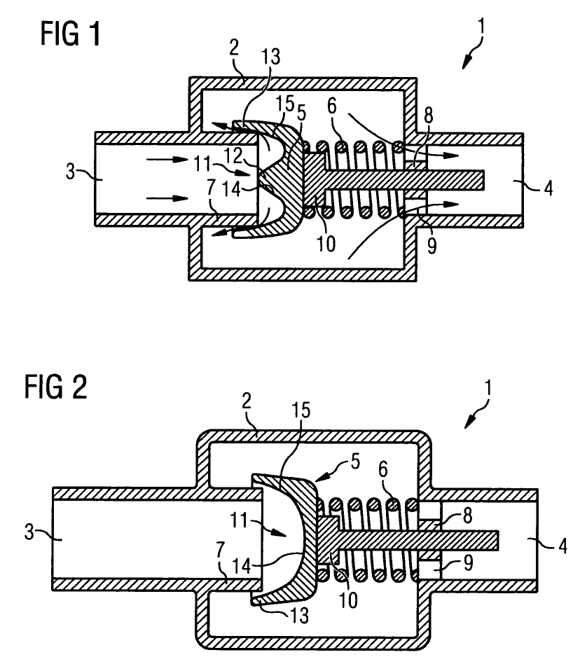

FIG. 1 shows a schematic, sectional representation of the valve according to the invention,

FIGS. 2-5 show further developments of the valve with various spring devices and embodiments of the housing and

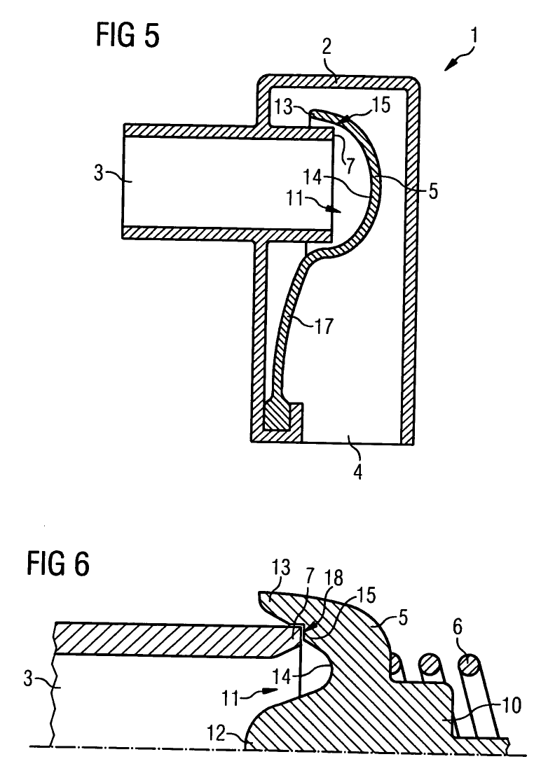

FIG. 6 shows an enlargement of the valve body and the sealing seat.

The valve represented in FIG. 1 is used as non-return valve in a fuel line. The valve 1 has a housing 2, which at its two end faces has an inlet 3 and an outlet 4, the inlet 3 extending into the housing 2. The inlet 3 and the outlet 4 can be connected to line ends (not shown) of the fuel line. The inlet 3 is closed by a valve body 5, which is pressed by a helical coil spring 6 against a sealing seat 7 at the inlet 3. For this purpose the valve body 5, on the side remote from the sealing seat, has a mounting 10 for the helical coil spring 6. At its end remote from the valve body 5 the helical coil spring 6 is supported against a web 8, which is provided with openings 9 for passage of the fuel.

On the side facing the sealing seat 7 the valve body 5 has a contour 11, which is formed by a centrally arranged central elevation 12 and a radially outwardly arranged peripheral elevation 13. The two elevations 12, 13 are connected to one another by a face 14 of concave design, in such a way that the contour 11 has no steps of any kind. The outside diameter of the valve body 5 is larger than the outside diameter of the inlet 3, so that with the valve 1 in the closed state the peripheral elevation 13 grips around the inlet 3. The inner flank 15 of the peripheral elevation 13 is at the same time designed as a sealing face, which bears against the sealing seat 7 of the inlet 3.

Provided that the fuel impinges on the inlet 3 with a pressure greater than the force generated by the helical coil spring 6, the valve body 5 will be moved in the direction of flow. The fuel flowing in strikes the central elevation 12, which directs the fuel radially outwards. The concave face 14 then directs the flow of fuel in the direction of the peripheral elevation 13, with the result that the fuel is deflected at an angle of more than 90° to the direction of flow. In the representation shown, the fuel flow is deflected at an angle of approximately 150°. Owing to the deflection, pulsation forces act on the valve body 5 on the rebound principle. The fuel then flows through the housing 2. The fuel flows on to the outlet 4 via the openings 9 in the web 8. The course of the flow is represented by means of arrows. Up to a volume flow rate of 300 l/h this valve has a virtually constant pressure. From a volume flow rate of 300 l/h to 500 l/h the pressure increases almost linearly by approximately 0.06 bar. Up to a volume flow rate of 300 l/h the valve 1 thereby has a horizontal characteristic curve. Only at greater rates of flow can any rise in the characteristic curve be plotted, the rise still being very shallow.

The valve 1 shown in FIG. 2 corresponds substantially to the construction of the valve 1 in FIG. 1. Only the contour 11 of the valve body 5 differs in that the concave face 14 is provided instead of the central elevation.

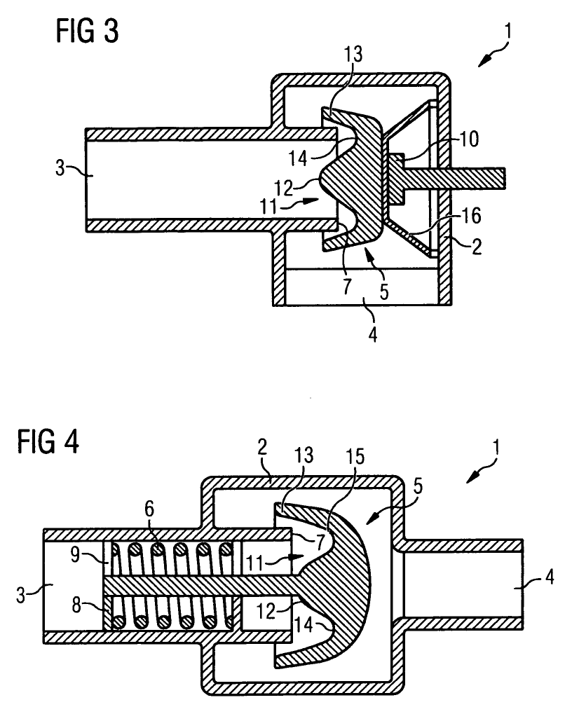

The valve 1 according to FIG. 3 has a housing 2 with a radial outlet 4. The valve body 5 is supported in a wall of the housing 2, on which the spring 16, which takes the form of a disk spring, also rests. In this development no web is needed with openings for the fuel to flow through. The radial outlet 4 and the use of the disk spring 16 mean that in axial extent the valve 1 takes up an especially small overall space. Assembly and manufacture are furthermore particularly easy.

The valve 1 according to FIG. 4 differs from the valve in FIG. 1 only in that the helical coil spring 6 is arranged upstream of the valve body 5, viewed in the direction of flow.

The valve 1 shown in FIG. 5 has a spring device in the form of a leaf spring 17, the leaf spring 17 and the valve body 5 being integrally formed. The fixing to the housing 2 makes the leaf spring 17 particularly easy to fit.

In the area of the inner flank 15 of the peripheral elevation 13 the valve body 5 in FIG. 6 forms a seal against the sealing seat 7 at the inlet 3. For this purpose the inner flank has an area in the form of a step, which conforms to the sealing seat 7 and which by virtue of its design configuration ensures a reliable seal.

1. A valve (1) for use in a fuel line of a motor vehicle, comprising a sealing seat (7), a valve body (5) which closes the sealing seat (7), and a spring device (6, 17), which pretensions the valve body (5) against the sealing seat, the valve body (5), on its side facing the sealing seat (7), having a contour (11) for deflecting the volume flow by an angle of more than 90°, and the outside diameter of the contour (11) being greater than the diameter of the sealing seat (7), characterized in that on its side facing the sealing seat (7) the valve body (5) has a radially outer peripheral elevation (13) for deflecting the flow, and in that the face (14) enclosed by the peripheral elevation (13) has a centrally arranged elevation (12).

2. The valve as claimed in claim 1, characterized in that the contour (11) of the valve body (5) is designed to deflect the flow within an angular range of 100° to 170°, in particular between 120° and 150°.

3. The valve as claimed in claim 1 or 2, characterized in that the radially inner flank (15) of the radially peripheral elevation (13) takes the form of a sealing face for interaction with the sealing seat (7).

4. The valve as claimed in claim 3, characterized in that the radially inner flank (15) of the radially peripheral elevation (13) has an area (18) which conforms to the shape of the sealing seat (7).

5. The valve as claimed in claim 1, characterized in that the face (14) of the valve body (5) enclosed by the peripheral elevation (13) is of concave design.

6. The valve as claimed in claim 1, characterized in that the contour (11) between the peripheral elevation (13) and the centrally arranged elevation (12) has a continuous profile.

7. The valve as claimed in claim 1, characterized in that the valve (1) is arranged in a housing (2).

8. The valve as claimed in claim 1, characterized in that the spring device is a helical coil spring (6).

9. The valve as claimed in claim 8, characterized in that the helical coil spring (6) is arranged downstream of the valve body (5) in the direction of flow.

10. The valve as claimed in claim 8, characterized in that the helical coil spring (6) is arranged upstream of the valve body (5) in the direction of flow.

11. The valve as claimed in claim 1, characterized in that the spring device is a disc spring (16).

12. The valve as claimed in claim 1, characterized in that the spring device is a leaf spring (17).

13. The valve as claimed in claim 12, characterized in that the leaf spring (17) is fixed to the housing (2).

14. The valve as claimed in claim 12, characterized in that the leaf spring (17) and the valve body (5) are integrally formed.
